(19) United States
(12) Patent Application Publication
(10) Pub. No.: US 2024/0185066 A1
(43) Pub. Date: Jun. 6, 2024

(54) DATA QUANTIZATION

(71) Applicant: TDK CORPORATION, Tokyo (JP)

(72) Inventors: Etienne De FORAS, SAINT NAZAIRE LES EYMES (FR); Minh Tri LE, Grenoble (FR)

(73) Assignee: TDK CORPORATION, Tokyo (JP)

(21) Appl. No.: 18/514,544

(22) Filed: Nov. 20, 2023

Related U.S. Application Data
(60) Provisional application No. 63/385,392, filed on Nov. 29, 2022.

(51) Int. Cl. G06N 3/08

(52) U.S. Cl. CPC G06N 3/08

(57) ABSTRACT

In a method for performing one bit quantization of data, data for training a neural network is received. The data is applied to a classifier of the neural network to determine classification probabilities for the data. A loss function is applied to the classification probabilities for the data, the loss function including a regularizer, where the regularizer forces weights of the classification probabilities to converge to binary integers, and where the regularizer exhibits a smooth curve with a continuously turning tangent at a midpoint. The quantized weights of the classification probabilities for the data is output.

### RELATED APPLICATION

This application claims priority to and the benefit of co-pending U.S. Provisional Patent Application 63/385,392, filed on Nov. 29, 2022, entitled “ONE BIT QUANTIZATION FOR EMBEDDED SYSTEMS,” by De Foras, et al., having Attorney Docket No. IVS-1063-PR, and assigned to the assignee of the present application, which is incorporated herein by reference in its entirety.

### BACKGROUND

Mobile electronic devices often have limited resources for computing ability, so it is beneficial to design systems within the mobile device to be efficient. For example, wearable devices that utilize sensors inputs to perform classification for identifying gestures typically have limited memory and processing power. As such, classification is limited to the on-device memory, requiring training of the classification probability within the constraints of the on-device memory.

### BRIEF DESCRIPTION OF DRAWINGS

The accompanying drawings, which are incorporated in and form a part of the Description of Embodiments, illustrate various non-limiting and non-exhaustive embodiments of the subject matter and, together with the Description of Embodiments, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1A is a block diagram illustrating an example system for performing one bit data quantization, in accordance with embodiments.

FIG. 1B is a block diagram illustrating an example system for performing one bit data quantization with a multiplexer, in accordance with embodiments.

FIG. 2A is a block diagram illustrating an example system for performing N bit data quantization, in accordance with embodiments.

FIG. 2B is a block diagram illustrating an example system for performing N bit data quantization with a multiplexer, in accordance with embodiments.

FIG. 3 is a block diagram illustrating an example data multiplexer, according to an embodiment.

FIG. 4A is a graph illustrating an example regularizer, according to an embodiment.

FIG. 4B is a graph illustrating example regularizers, according to embodiments.

FIGS. 5A through 5C are graphs illustrating example N bit quantization, according to embodiments.

FIG. 6 is a graph illustrating example decay functions, according to embodiments.

FIGS. 7A through 7C are line graphs illustrating one bit quantization over a number of epochs, according to an embodiment.

FIG. 8 is a block diagram illustrating an example computer system upon which embodiments of the present invention can be implemented.

FIG. 9 is a flow diagram illustrating an example method for one bit data quantization, according to embodiments.

FIG. 10 is a flow diagram illustrating an example method for N bit data quantization, according to embodiments.

### DETAILED DESCRIPTION

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “identifying,” “analyzing,” “processing,” “determining,” “cancelling,” “continuing,” “comparing,” “generating,” “applying,” “outputting,” or the like, refer to the actions and processes of an electronic device such as an electrical device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example ultrasonic sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example system for performing one bit data quantization, according to various embodiments. An example system 100 for performing N bit data quantization is then described. An example computer system environment, upon which embodiments of the present invention may be implemented, is then described. Example operations of one bit data quantization and N bit data quantization are then described.

Example embodiments described herein provide methods for performing one bit quantization of data. Data for training a neural network is received. The data is applied to a classifier of the neural network to determine classification probabilities for the data. A loss function is applied to the classification probabilities for the data, the loss function including a regularizer, where the regularizer forces weights of the classification probabilities to converge to binary integers, and where the regularizer exhibits a smooth curve with a continuously turning tangent at a midpoint. In some embodiments, the regularizer comprises a Euclidean regularizer. In some embodiments, the regularizer comprises a Cosinus regularizer. In some embodiments, the regularizer comprises a Manhattan regularizer. In some embodiments, the regularizer further exhibits real angles at the binary integers.

In some embodiments, a decay function is applied to the regularizer over a number of epochs to force convergence to the binary integers. In some embodiments, the decay function comprises at least one of: linear, quadratic polynomial, n-polynomial, inverse linear decay, inverse polynomial decay, step-based inverse linear decay, step-based bounded decay, and step-based linear decay. The one bit quantized weights of the classification probabilities for the data is output.

Other example embodiments described herein provide methods for performing N bit quantization of data. Data for training a neural network is received. The data is multiplexed and scaled according to multipliers. The multiplexed data is applied to a classifier of the neural network to determine classification probabilities for the data. A loss function is applied to the classification probabilities for the data, the loss function including a regularizer, where the regularizer forces weights of the classification probabilities to converge to binary integers, and where the regularizer exhibits a smooth curve with a continuously turning tangent at a midpoint. In some embodiments, the regularizer comprises a Euclidean regularizer. In some embodiments, the regularizer comprises a Cosinus regularizer. In some embodiments, the regularizer comprises a Manhattan regularizer. In some embodiments, the regularizer further exhibits real angles at the binary integers.

In some embodiments, a decay function is applied to the regularizer over a number of epochs to force convergence to the binary integers. In some embodiments, the decay function comprises at least one of: linear, quadratic polynomial, n-polynomial, inverse linear decay, inverse polynomial decay, step-based inverse linear decay, step-based bounded decay, and step-based linear decay. N values of the quantized weights of the classification probabilities for the data are output as N bit quantized weights.

### Example Systems for Data Quantization

Example embodiments described herein provide methods for performing one bit quantization of data. Data for training a neural network is received. The data is applied to a classifier of the neural network to determine classification probabilities for the data as one bit quantized weights. A loss function is applied to the classification probabilities for the data, the loss function including a regularizer, where the regularizer forces weights of the classification probabilities to converge to binary integers, and where the regularizer exhibits a smooth curve with a continuously turning tangent at a midpoint. The quantized weights of the classification probabilities for the data is output as the one bit quantized weights.

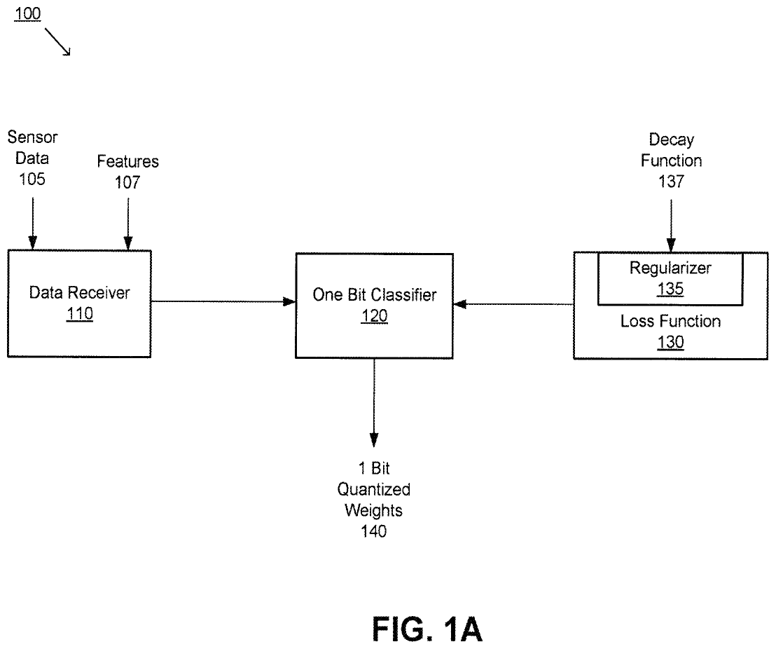

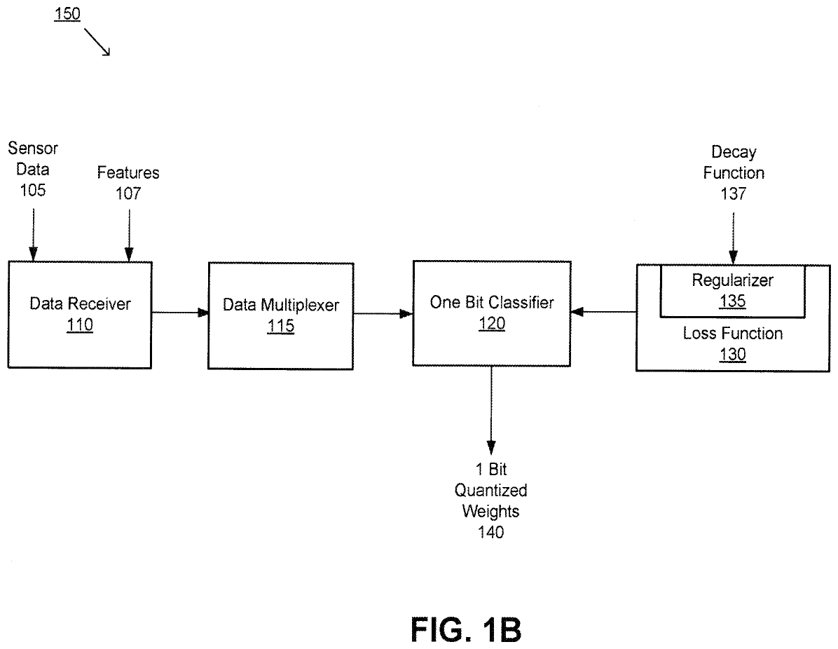

FIG. 1A is a block diagram illustrating an example system 100 for performing one bit data quantization, in accordance with embodiments. In accordance with various embodiments, system 100 includes data receiver 110, one bit classifier 120, and loss function 130. It should be appreciated that data receiver 110, one bit classifier 120, and loss function 130 can be under the control of a single component of an enterprise computing environment (e.g., a distributed computer system or computer system 800) or can be distributed over multiple components (e.g., a virtualization infrastructure or a cloud-based infrastructure). In some embodiments, system 100 is comprised within or is an enterprise system.

Sensor data 105 and features 107 is received at data receiver 110. For instance, sensor data 105 may first go through a pre-processing stage which may include eliminating noise in sensor data 105 and putting sensor data 105 in a more appropriate format for performing classification. Next, sensor data 105 may go through the feature extraction stage where sensor data 105 is analyzed (e.g., without labels) for what activity the data might portray. Next, in the feature selection stage, the less important features are filtered out, and the more important features are retained. The feature selection may be done through a numerical threshold, human input, redundancy, or similar filtering methods.

Features 107 may include mean, variance, energy, number of peaks, peak distance, mean cross rate, dominant frequencies, spectral power, etc. Sensor data 105 may be maintained within a labeled database that includes corresponding labels to what activity the data describes. For example, if sensor data 105 includes a set of motion data from a person running, then the data will be labeled as running. Other activities may include walking, sleeping, sitting, driving, exercising, etc.

Sensor data 105 and features 107 are received at one bit classifier 120 for performing machine learning classification. Sensor data 105 and features 107 are applied to one bit classifier 120 of the neural network to determine classification probabilities for sensor data 105 and features 107.

Loss function 130 is applied to the classification probabilities for sensor data 105 and features 107. Loss function 130 includes regularizer 135 that forces weights of the classification probabilities to converge to binary integers. In some embodiments, regularizer 135 exhibits a smooth curve with a continuously turning tangent at a midpoint. One bit classifier 120 outputs the quantized weights of the classification probabilities for sensor data 105 and features 107 as one bit quantized weights 140.

In accordance with described embodiments, regularizer 135 is added to loss function 130 that force the weights to converge to +1 or −1 over epochs. Equation 1 is an example loss function 130 plus regularizer 135:

Loss function: J(W;x,y)=L(f(x,W),y)+λ·Reg(W) (1)

The weight values are penalized by a Reg function, and this can be tuned through λ. The regularizer has two minimal values: −1 and +1. The weights far from these values will be penalized and updated more frequently. In some embodiments, regularizer 135 comprises a Euclidean regularizer. In some embodiments, regularizer 135 comprises a Cosinus regularizer. In some embodiments, regularizer 135 comprises a Manhattan regularizer. In some embodiments, regularizer 135 further exhibits real angles at the binary integers.

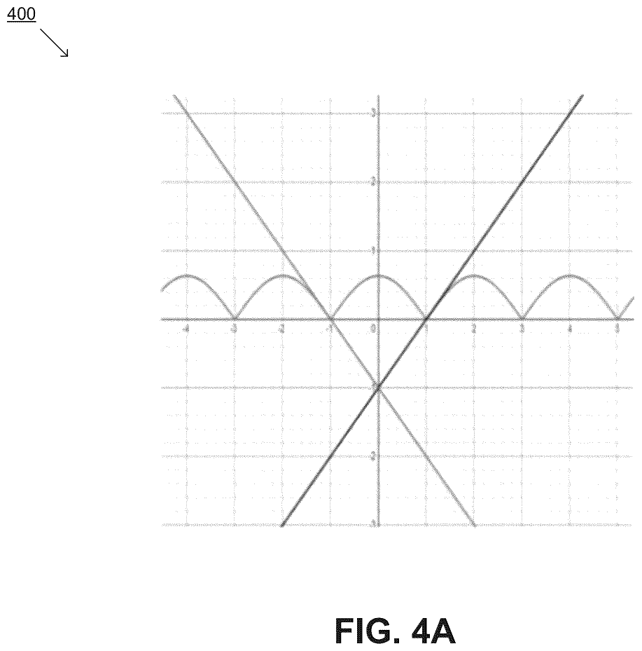

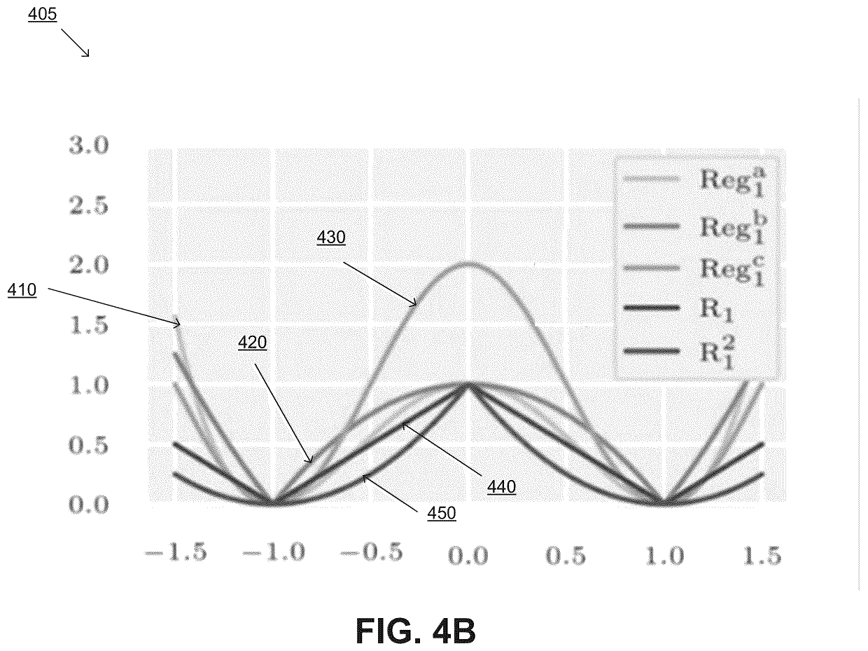

FIG. 4A is a graph 400 illustrating an example regularizer, according to an embodiment. Graph 400 illustrates the following example regularizer, shown in Equation 2:

if −1≤x and x≥1

Loss=|(cos π*n*x)/(π*n)|

Else

If x>1

Loss=+x+1

Else

Loss=−x−1 (2)

In accordance with the described embodiments, a regularizer as used herein, such as the example regularizer of Equation 2, can include at least one of the following properties:
Exhibits a smooth curve with a continuously turning tangent at the midpoint (e.g., vertical axis). Such a curve does not include a gradient sign change, and allows for better convergence;
Exhibits a narrow angle at binary pits. Weights can have only one value, allowing for better accuracy after quantization;
Can handle any number of bits for quantization. For example, the regularizer can use any half period of the Cosinus; and
Can return to zero. For example, can use an absolute value if needed.

As illustrated, the regularizer of graph 400 exhibits a smooth curve with a continuously turning tangent at a midpoint. It should be appreciated that any regularizer that exhibits one or more of the above described properties can be utilized herein. FIG. 4B is a graph 405 illustrating example regularizers, according to embodiments.

Graph 405 includes example regularizers 410, 420, and 430 that can be utilized in accordance with the described embodiments. Regularizer 410, illustrated below as Equation 3, is a Euclidean regularizer.

Reg₁¹(w)=(w²−1)² (3)

Regularizer 420, illustrated below as Equation 4, is a Manhattan regularizer.

Reg₁^{b}(w)=|w²−1| (4)

Regularizer 430, illustrated below as Equation 5, is a Cosinus regularizer.

$$R e {g}_{1}^{c} ( w ) = \{ \begin{matrix}cos ( πω ) + 1 & if \vert w \vert \leq 3 / 2 \\ π ( \vert w \vert - 3 / 2 ) + 1 & if \vert w \vert > 3 / 2\end{matrix} \qquad ( 5 )$$

Regularizers 440 (R₁) and 450 (R₁²) are examples of regularizers that do not exhibit desirable properties. For example, regularizers 440 and 450 both do not exhibit a smooth curve with a continuously turning tangent at a midpoint, but rather a sharp angle at the midpoint. Regularizer 450 also does not exhibit a narrow angle at the binary bits, but rather a smooth curve. Accordingly, regularizers 440 and 450 may not be as desirable as regularizers 410, 420, and 430, for use in the described embodiments.

With reference to FIG. 1A, in some embodiments, system 100 also includes decay function 137. Decay function 137 is applied to regularizer 135 over a number of epochs to force convergence to the binary integers over time. In accordance with various embodiments, decay function 137 includes at least one of: a linear decay function, a quadratic polynomial decay function, an n-polynomial decay function, an inverse linear decay function, an inverse polynomial decay function, a step-based inverse linear decay function, a step-based bounded decay function, and a step-based linear decay function.

In accordance with various embodiments, decay function 137 exhibits at least one of the following properties:

$$decay ( t = 1 ) \approx 0 or \geq 0$$

$$decay ( t = {t}_{final} ) \approx 1 or \leq 1$$

$$decay ( t ) ∈ [ 0 ; 1 ] and ∈ [ decay ( 0 ) ; decay ( {t}_{final} ) ]$$

$$\frac{decay ( t )}{dt} \geq 0$$

$$Reg ( x , t ) = R e g ( x ) * decay ( t ) for t ∈ [ 0 ; {t}_{final} ]$$

The following decay functions shown in Equations 6 through 13 are examples of decay functions that can be use in the described embodiments, either or alone or in combination:

Linear decay function:

$$decay ( t , {t}_{f inal} ) = \frac{t - 1}{{t}_{final - 1}} \qquad ( 6 )$$

Quadratic decay function:

$$decay ( t , {t}_{f inal} ) = \frac{1}{{t}_{final}^{2} - 1} * {t}^{2} - \frac{1}{{t}_{final}^{2} - 1} \qquad ( 7 )$$

N-polynomial decay function:

$$decay ( t , {t}_{f inal} , N ) = {( \frac{t}{{t}_{final}} )}^{N} \qquad ( 8 )$$

Inverse linear decay function:

$$decay ( t , d = 0.01 ) = \frac{1}{1 + \frac{1}{d * t}} \qquad ( 9 )$$

Inverse polynomial decay function:

$$decay ( t , d = 0.001 ) = \frac{1}{1 + \frac{1}{d * {t}^{2}}} \qquad ( 10 )$$

Step-based inverse linear decay function:

$$scale ( rate = 0.8 , {t}_{final} , {step}_{epoch} = 10 ) = \frac{1}{{rate}^{floor ( \frac{{t}_{final}}{{step}_{e p o c h}} )}} ; \\ decay ( t , rate = 0.8 , {step}_{epoch} = 10 ) = \frac{1}{scale * {rate}^{floor ( \frac{{t}_{final}}{{step}_{epoch}} )}} \qquad ( 11 )$$

Step-based bounded decay function:

$$decay ( t , rate = 0.8 , {step}_{epoch} = 10 ) = 1 - {rate}^{floor ( \frac{t}{{step}_{e p o c h}} )} \qquad ( 12 )$$

Step-based linear decay function:

$$decay ( t , {t}_{final} , {step}_{epoch = 10} ) = \frac{floor ( t / {step}_{epoch} )}{floor ( {t}_{f i n a l} / {step}_{epoch} )} \qquad ( 13 )$$

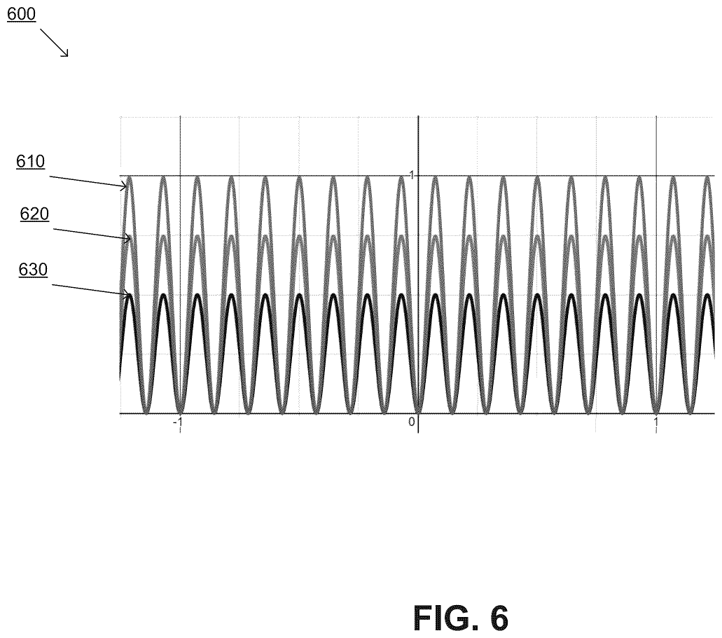

FIG. 6 is a graph 600 illustrating example decay functions, according to embodiments. As illustrated, decay function 610 is a linear decay function, such as the decay function recited in Equation 6. As illustrated, decay function 620 is an N-polynomial decay function, such as the decay function recited in Equation 8. As illustrated, decay function 630 is a step-based inverse linear decay function, such as the decay function recited in Equation 10. As described above, it should be appreciated that embodiments herein can utilize any of the described decay functions, either alone or in combination, as well as other decay functions for forcing the weights to converge to quantized data.

Returning to FIG. 1A, Sensor data 105 and features 107 are received at one bit classifier 120 for performing machine learning classification. Sensor data 105 and features 107 are applied to one bit classifier 120 of the neural network to determine classification probabilities for sensor data 105 and features 107, where one bit classifier 120 is subjected to loss function 130. The classification probabilities are output as one bit quantized weights 140.

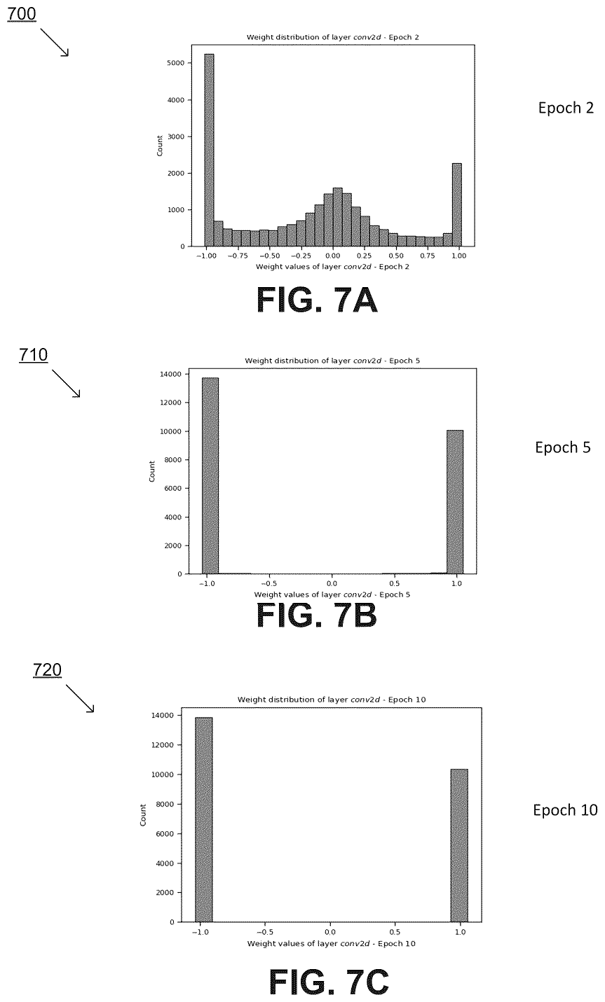

FIGS. 7A through 7C are line graphs illustrating one bit quantization over a number of epochs, according to an embodiment. After two epochs, as shown in line graph 700 of FIG. 7A, the data is shown to converges towards either −1 or 1, with some data still requiring additional epochs for convergence. As shown in line graph 710 of FIG. 7B, after five epochs almost all data is converged, and as shown at line graph 720 of FIG. 7C, after ten epochs, all data is quantized as −1 or 1. It should be appreciated that FIGS. 7A through 7C are examples of one bit quantization over a number of epochs, and different data may require different numbers of epochs for convergence.

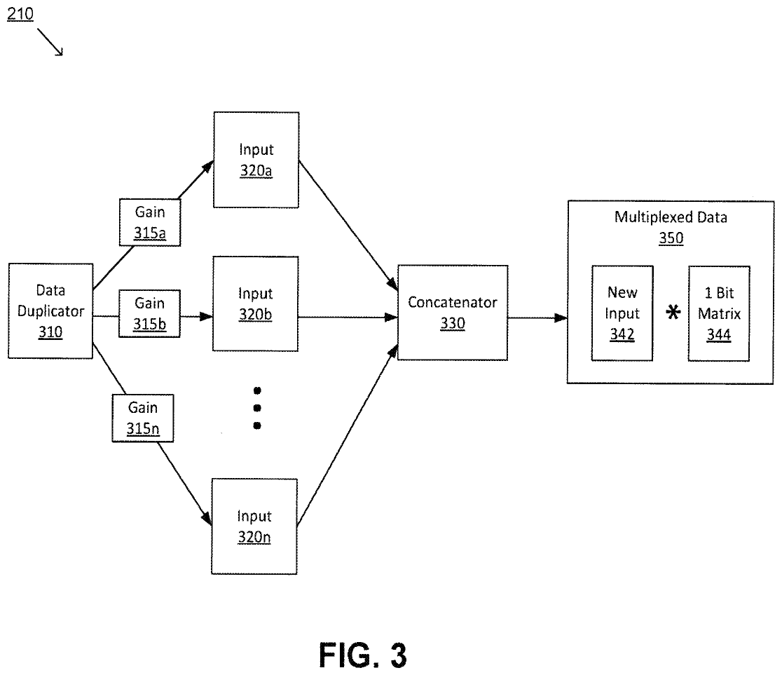

FIG. 1B is a block diagram illustrating an example system 150 for performing one bit data quantization with a multiplexer, in accordance with embodiments. It should be appreciated that system 150 operates in substantially the same manner as system 100 of FIG. 1A, as described above, with the addition of data multiplexer 115. Sensor data 105 and features 107 is received at data receiver 110. Sensor data 105 and features 107 are then received at data multiplexer 115 for enabling one bit quantization. In some embodiments, data multiplexer 115 is implemented as data multiplexer 300 of FIG. 3.

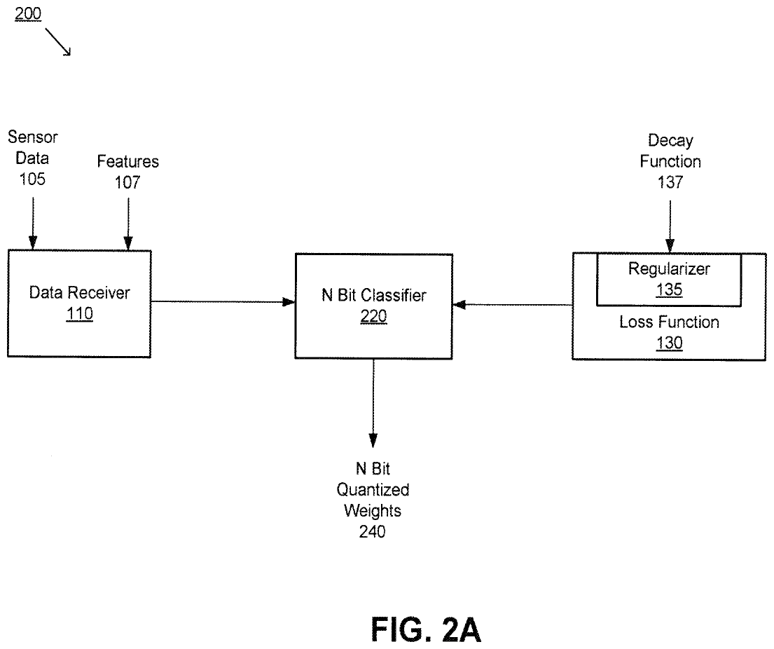

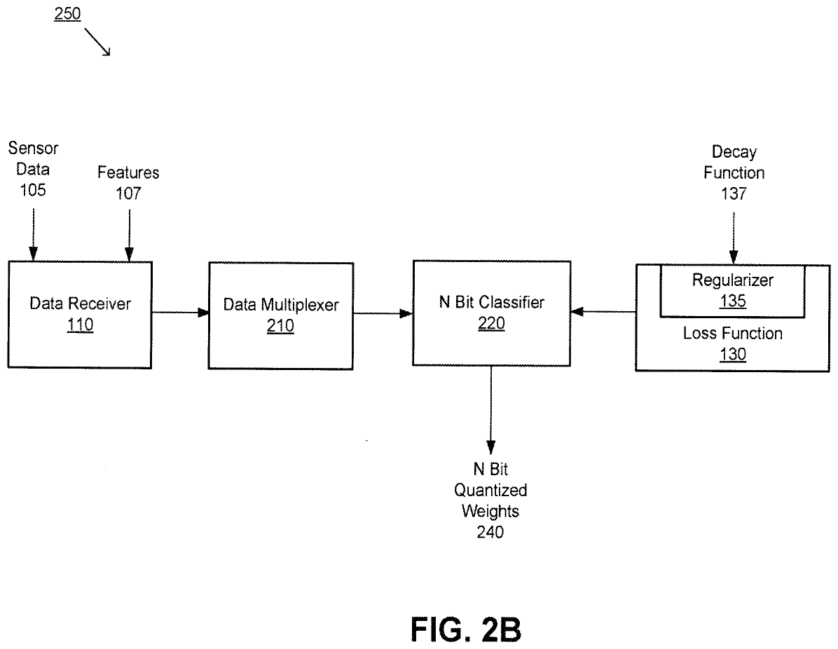

FIG. 3 is a block diagram illustrating an example data multiplexer 300, according to an embodiment. Data (e.g., sensor data 105 and/or features 107) is received at data duplicator 310 of data multiplexer 300. Data duplicator 310 is configured to duplicate the input data according to the number of bits (N bits) that are the intended output of classification (e.g., at one classifier 120 of FIG. 1B or N bit classifier 220 of FIG. 2B). As illustrated, data is duplicated any number of times, with three explicit instances shown. The duplicated data is then multiplied at gain 315a through 315n, where each gain 315a through 315n has a different multiplier. For example, each instance of the duplicated data can be multiplied by a power of two relative to other instances, or any other fixed or trained value. The duplicated instances, after being multiplied by respective gains 315a through 315n, are realized as inputs 320a through 320n. Inputs 320a through 320n are received at concatenator 330 that concatenates inputs 320a through 320n in a window to make a new input 342. New input 342 is multiplied by a one bit matrix to generate the output multiplexed data 350, where multiplexed data 350 is a binary combination of inputs multiplied with weights.

Other example embodiments described herein provide methods for performing N bit quantization of data. Data for training a neural network is received. The data is multiplexed and scaled according to multipliers. The multiplexed data is applied to a classifier of the neural network to determine classification probabilities for the data as N bit quantized weights. A loss function is applied to the classification probabilities for the data, the loss function including a regularizer, where the regularizer forces weights of the classification probabilities to converge to binary integers, and where the regularizer exhibits a smooth curve with a continuously turning tangent at a midpoint. N values of the quantized weights of the classification probabilities for the data are output as N bit quantized weights.

FIG. 2A is a block diagram illustrating an example system 200 for performing N bit data quantization, in accordance with embodiments. In accordance with various embodiments, system 200 includes data receiver 110, N bit classifier 220, and loss function 130. It should be appreciated that data receiver 110, classifier 220, and loss function 130 can be under the control of a single component of an enterprise computing environment (e.g., a distributed computer system or computer system 800) or can be distributed over multiple components (e.g., a virtualization infrastructure or a cloud-based infrastructure). In some embodiments, system 200 is comprised within or is an enterprise system. It should also be appreciated that data receiver 110 and loss function 130 of system 200 operate in a substantially similar manner as described above in accordance with FIG. 1A, with N bit classifier 220 being configured to perform N bit classification for generating N bit quantized weights 240.

FIG. 2B is a block diagram illustrating an example system 200 for performing N bit data quantization with a multiplexer, in accordance with embodiments. In accordance with various embodiments, system 200 includes data receiver 110, data multiplexer 210, N bit classifier 220, and loss function 130. It should be appreciated that data receiver 110, data multiplexer 210, classifier 220, and loss function 130 can be under the control of a single component of an enterprise computing environment (e.g., a distributed computer system or computer system 800) or can be distributed over multiple components (e.g., a virtualization infrastructure or a cloud-based infrastructure). In some embodiments, system 200 is comprised within or is an enterprise system. It should also be appreciated that data receiver 110, N bit classifier 220, and loss function 130 of system 200 operate in a substantially similar manner as described above in accordance with FIG. 1A. Sensor data 105 and features 107 is received at data receiver 110. Sensor data 105 and features 107 are then received at data multiplexer 210 for enabling N bit quantization (where N is a positive integer). In some embodiments, data multiplexer 210 is implemented as data multiplexer 300 of FIG. 3.

With reference to FIG. 3, data (e.g., sensor data 105 and/or features 107) is received at data duplicator 310 of data multiplexer 210. Data duplicator 310 is configured to duplicate the input data according to the number of bits (N bits) that are the intended output of classification (e.g., at N bit classifier 220 of FIG. 2B). As illustrated, data is duplicated any number of times, with three explicit instances shown. The duplicated data is then multiplied at gain 315a through 315n, where each gain 315a through 315n has a different multiplier. For example, each instance of the duplicated data can be multiplied by a power of two relative to other instances, or any other fixed or trained value. The duplicated instances, after being multiplied by respective gains 315a through 315n, are realized as inputs 320a through 320n. Inputs 320a through 320n are received at concatenator 330 that concatenates inputs 320a through 320n in a window to make a new input 342. New input 342 is multiplied by a one bit matrix to generate the output multiplexed data 350, where multiplexed data 350 is a binary combination of inputs multiplied with weights.

With reference to FIG. 2B, multiplexed data 350 (including sensor data and features) are received at N bit classifier 220 for performing machine learning classification. Multiplexed data 350 are applied to N bit classifier 220 of the neural network to determine classification probabilities for sensor data 105 and features 107.

Loss function 130 is applied to the classification probabilities for sensor data 105 and features 107. Loss function 130 includes regularizer 135 that forces weights of the classification probabilities to converge to binary integers. In some embodiments, regularizer 135 exhibits a smooth curve with a continuously turning tangent at a midpoint. N bit classifier 220 outputs the quantized data of the classification probabilities for sensor data 105 and features 107 as N bit quantized weights 240.

In accordance with described embodiments, regularizer 135 is added to loss function 130 that force the weights to converge to N values over epochs. Equation 1 described above is an example loss function 130 plus regularizer 135. Equation 14 is an example regularizer 135:

Reg_{N}(W,n)=Σ_{w∈W} cos(n*π*w+π)+1 (14)
Where the local minima with n an even number, are the set of values defined by (Equation 15):

$$min {Reg}_{N} ( W , k ) = \{ \frac{n}{\frac{k}{2} - 1} \} n ∈ Z \qquad ( 15 )$$

where N bit regularization can extend to any number of bits by tuning the integer n.

In some embodiments, regularization function is made into a piecewise function by adding symmetric border function that highly penalizes weights outside of the range [−1; +1]. This can be any positive function that have a high magnitude outside of the range [−1; +1]. In some embodiments, a linear function g(x)=a₁*x+b (and its symmetric with a₁=−a₁) is used so that the transition between the regularization function and border function is smooth using same derivative at the transition point as shown in Equations 16 and 17:

f(a)=g(a) (16)

f′(a)=g′(a) (17)

It should be appreciated that in accordance with various embodiments, the transition point a is arbitrarily chosen or user-defined, e.g., so that Reg(a) is about three quarters of its maximal magnitude.

In some embodiments, regularizer 135 comprises a Euclidean regularizer. In some embodiments, regularizer 135 comprises a Cosinus regularizer. In some embodiments, regularizer 135 comprises a Manhattan regularizer. In some embodiments, regularizer 135 further exhibits real angles at the binary integers.

FIGS. 4A and 4B, described above, are example regularizers that can be used in accordance with the described embodiments. In accordance with the described embodiments, a regularizer as used herein, such as the example regularizer of Equation 2, can include at least one of the following properties:
Exhibits a smooth curve with a continuously turning tangent at the midpoint (e.g., vertical axis). Such a curve does not include a gradient sign change, and allows for better convergence;
Exhibits a narrow angle at binary pits. Weights can have only one value, allowing for better accuracy after quantization;
Can handle any number of bits for quantization. For example, the regularizer can use any half period of the Cosinus; and
Can return to zero. For example, can use an absolute value if needed.

With reference to FIG. 2B, in some embodiments, system 200 also includes decay function 137. Decay function 137 is applied to regularizer 135 over a number of epochs to force convergence to the binary integers over time. In accordance with various embodiments, decay function 137 includes at least one of: a linear decay function, a quadratic polynomial decay function, an n-polynomial decay function, an inverse linear decay function, an inverse polynomial decay function, a step-based inverse linear decay function, a step-based bounded decay function, and a step-based linear decay function, as described above in Equations 6 through 13.

Multiplexed data 350 (e.g., including sensor data 105 and features 107) is received at N bit classifier 220 for performing machine learning classification. Sensor data 105 and features 107 are applied to N bit classifier 220 of the neural network to determine classification probabilities for sensor data 105 and features 107, where N bit classifier 220 is subjected to loss function 130. The classification probabilities are output as N bit quantized weights 240.

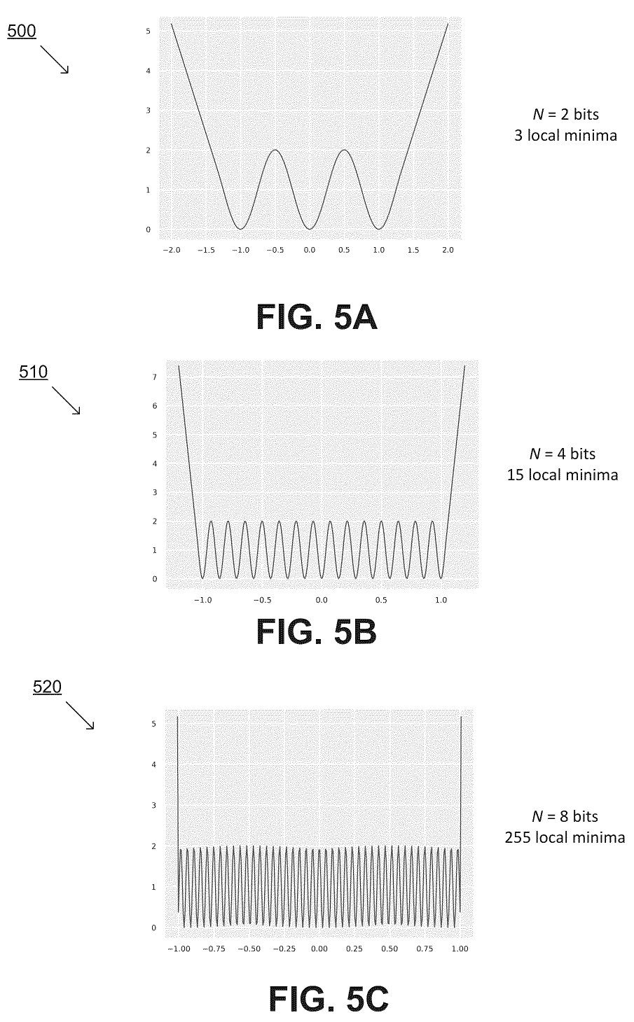

FIGS. 5A through 5C are graphs illustrating example N bit quantization, according to embodiments. As illustrated in FIG. 5A, two bit quantization of data is shown at graph 500, where N=2 bits and there are three local minima. As illustrated in FIG. 5B, four bit quantization of data is shown at graph 510, where N=4 bits and there are fifteen local minima. As illustrated in FIG. 5C, eight bit quantization of data is shown at graph 520, where N=8 bits and there are two hundred fifty-five local minima.

### Example Computer System

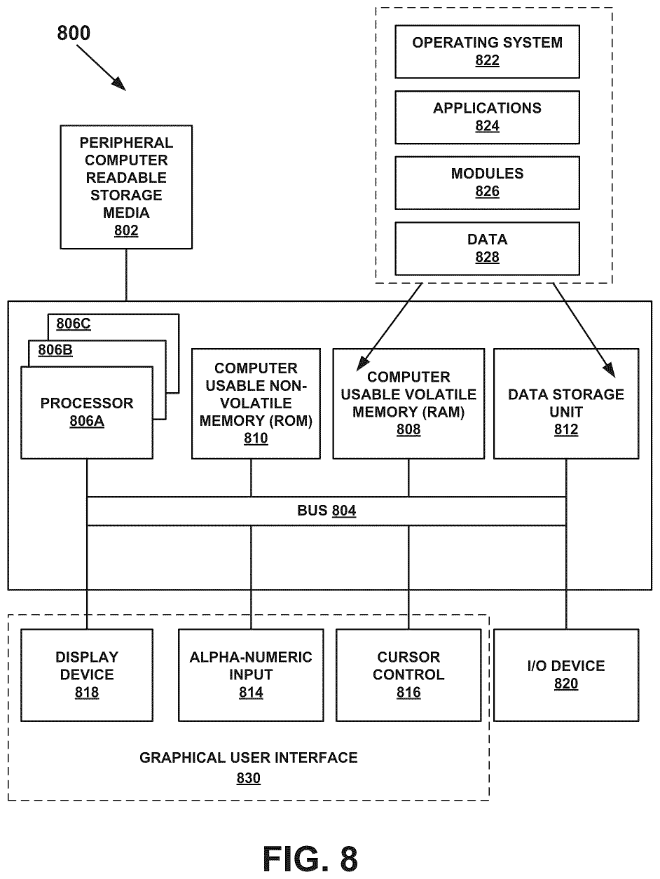

FIG. 8 is a block diagram of an example computer system 800 upon which embodiments of the present invention can be implemented. FIG. 8 illustrates one example of a type of computer system 800 (e.g., a computer system) that can be used in accordance with or to implement various embodiments which are discussed herein.

It is appreciated that computer system 800 of FIG. 8 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 800 of FIG. 8 is well adapted to having peripheral tangible computer-readable storage media 802 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 800 of FIG. 8 includes an address/data bus 804 for communicating information, and a processor 806A coupled with bus 804 for processing information and instructions. As depicted in FIG. 8, computer system 800 is also well suited to a multi-processor environment in which a plurality of processors 806A, 806B, and 806C are present. Conversely, computer system 800 is also well suited to having a single processor such as, for example, processor 806A. Processors 806A, 806B, and 806C may be any of various types of microprocessors. Computer system 800 also includes data storage features such as a computer usable volatile memory 808, e.g., random access memory (RAM), coupled with bus 804 for storing information and instructions for processors 806A, 806B, and 806C. Computer system 800 also includes computer usable non-volatile memory 810, e.g., read only memory (ROM), coupled with bus 804 for storing static information and instructions for processors 806A, 806B, and 806C. Also present in computer system 800 is a data storage unit 812 (e.g., a magnetic or optical disc and disc drive) coupled with bus 804 for storing information and instructions. Computer system 800 also includes an alphanumeric input device 814 including alphanumeric and function keys coupled with bus 804 for communicating information and command selections to processor 806A or processors 806A, 806B, and 806C. Computer system 800 also includes a cursor control device 816 coupled with bus 804 for communicating user input information and command selections to processor 806A or processors 806A, 806B, and 806C. In one embodiment, computer system 800 also includes a display device 818 coupled with bus 804 for displaying information.

Referring still to FIG. 8, display device 818 of FIG. 8 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 816 allows the computer user to dynamically signal the movement of a visible symbol (cursor) on a display screen of display device 818 and indicate user selections of selectable items displayed on display device 818. Many implementations of cursor control device 816 are known in the art including a trackball, mouse, touch pad, touch screen, joystick or special keys on alphanumeric input device 814 capable of signaling movement of a given direction or manner of displacement. Alternatively, it will be appreciated that a cursor can be directed and/or activated via input from alphanumeric input device 814 using special keys and key sequence commands. Computer system 800 is also well suited to having a cursor directed by other means such as, for example, voice commands. In various embodiments, alphanumeric input device 814, cursor control device 816, and display device 818, or any combination thereof (e.g., user interface selection devices), may collectively operate to provide a graphical user interface (GUI) 830 under the direction of a processor (e.g., processor 806A or processors 806A, 806B, and 806C). GUI 830 allows user to interact with computer system 800 through graphical representations presented on display device 818 by interacting with alphanumeric input device 814 and/or cursor control device 816.

Computer system 800 also includes an I/O device 820 for coupling computer system 800 with external entities. For example, in one embodiment, I/O device 820 is a modem for enabling wired or wireless communications between computer system 800 and an external network such as, but not limited to, the Internet. In one embodiment, I/O device 820 includes a transmitter. Computer system 800 may communicate with a network by transmitting data via I/O device 820. In accordance with various embodiments, I/O device 820 includes a microphone for receiving human voice or speech input (e.g., for use in a conversational or natural language interface).

Referring still to FIG. 8, various other components are depicted for computer system 800. Specifically, when present, an operating system 822, applications 824, modules 826, and data 828 are shown as typically residing in one or some combination of computer usable volatile memory 808 (e.g., RAM), computer usable non-volatile memory 810 (e.g., ROM), and data storage unit 812. In some embodiments, all or portions of various embodiments described herein are stored, for example, as an application 824 and/or module 826 in memory locations within RAM 808, computer-readable storage media within data storage unit 812, peripheral computer-readable storage media 802, and/or other tangible computer-readable storage media.

### Example Methods of Operation

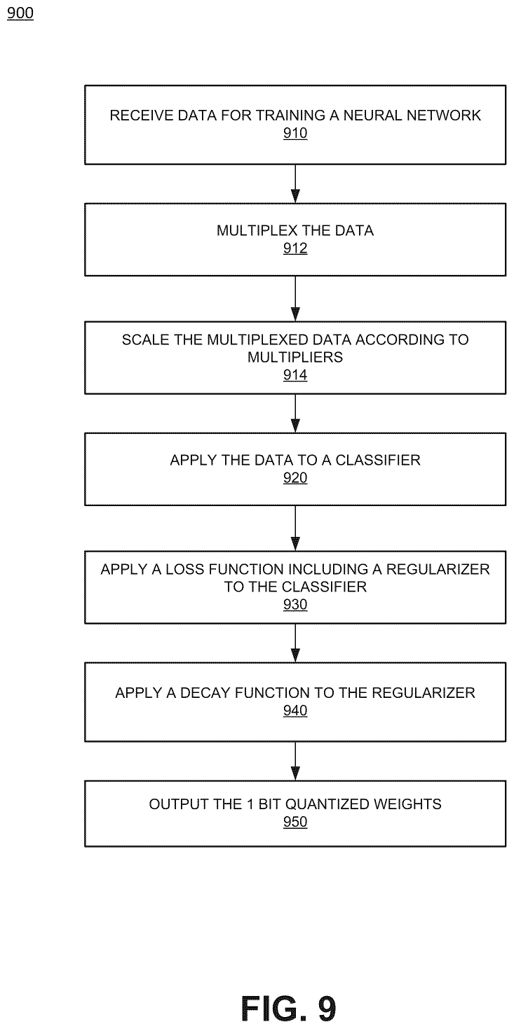

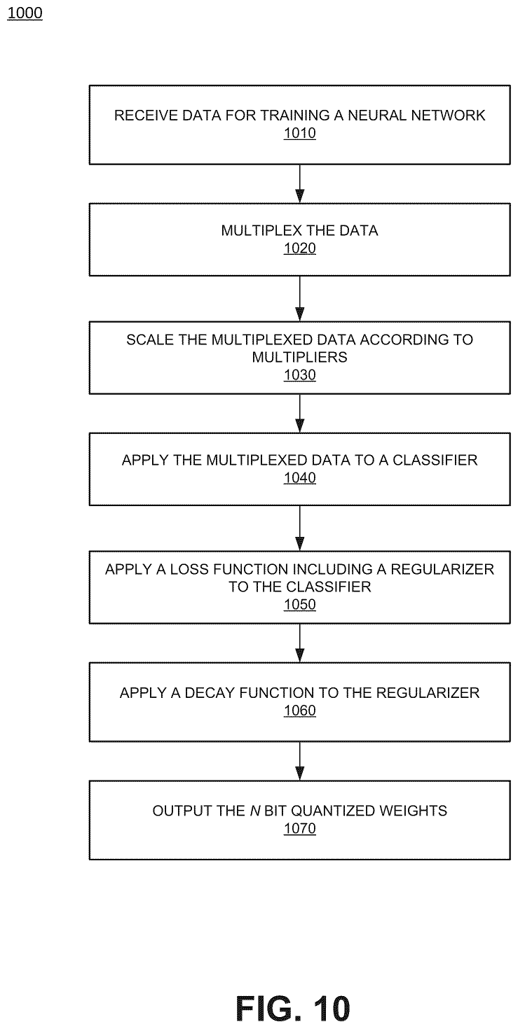

The following discussion sets forth in detail the operation of some example methods of operation of embodiments. With reference to FIGS. 9 and 10, flow diagrams 900 and 1000 illustrate example procedures used by various embodiments. The flow diagrams include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 800). The computer-readable and computer-executable instructions, which reside on tangible computer readable storage media, are used to control, or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited for performing various other procedures or variations of the procedures recited in the flow diagram. Likewise, in some embodiments, the procedures in the flow diagrams may be performed in an order different than presented and/or not all the procedures described in the flow diagrams may be performed. It is further appreciated that procedures described in the flow diagrams may be implemented in hardware, or a combination of hardware with firmware and/or software provided by computer system 800.

FIG. 9 is a flow diagram 900 illustrating an example method performing one bit quantization of data, according to embodiments. At procedure 910 of flow diagram 900, data for training a neural network is received. In accordance with some embodiments, where a data multiplexer is used, at procedure 912, the data is multiplexed and at procedure 914, the data is scaled according to multipliers. At procedure 920, the data is applied to a classifier of the neural network to determine classification probabilities for the data. In some embodiments, where the data is multiplexed, the multiplexed data is applied to the classifier at procedure 920. At procedure 930, a loss function is applied to the classification probabilities for the data, the loss function including a regularizer, where the regularizer forces weights of the classification probabilities to converge to binary integers, and where the regularizer exhibits a smooth curve with a continuously turning tangent at a midpoint. In some embodiments, the regularizer comprises a Euclidean regularizer. In some embodiments, the regularizer comprises a Cosinus regularizer. In some embodiments, the regularizer comprises a Manhattan regularizer. In some embodiments, the regularizer further exhibits real angles at the binary integers.

In some embodiments, as shown at procedure 940, a decay function is applied to the regularizer over a number of epochs to force convergence to the binary integers. In some embodiments, the decay function comprises at least one of: linear, quadratic polynomial, n-polynomial, inverse linear decay, inverse polynomial decay, step-based inverse linear decay, step-based bounded decay, and step-based linear decay. At procedure 950, the one bit quantized weights of the classification probabilities for the data is output.

FIG. 10 is a flow diagram 1000 illustrating an example method for N bit data quantization, according to embodiments. At procedure 1010 of flow diagram 1000. data for training a neural network is received. In accordance with some embodiments, as shown at procedure 1020, the data is multiplexed and at procedure 1030, the data is scaled according to multipliers. At procedure 1040, the data is applied to a classifier of the neural network to determine classification probabilities for the data. In some embodiments, where the data is multiplexed, the multiplexed data is applied to the classifier at procedure 1040. At procedure 1050, a loss function is applied to the classification probabilities for the data, the loss function including a regularizer, where the regularizer forces weights of the classification probabilities to converge to binary integers, and where the regularizer exhibits a smooth curve with a continuously turning tangent at a midpoint. In some embodiments, the regularizer comprises a Euclidean regularizer. In some embodiments, the regularizer comprises a Cosinus regularizer. In some embodiments, the regularizer comprises a Manhattan regularizer. In some embodiments, the regularizer further exhibits real angles at the binary integers.

In some embodiments, as shown at procedure 1060, a decay function is applied to the regularizer over a number of epochs to force convergence to the binary integers. In some embodiments, the decay function comprises at least one of: linear, quadratic polynomial, n-polynomial, inverse linear decay, inverse polynomial decay, step-based inverse linear decay, step-based bounded decay, and step-based linear decay. At procedure 1070, N values of the quantized weights of the classification probabilities for the data are output as N bit quantized weights.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

1. A method for performing one bit quantization of data, the method comprising:
receiving data for training a neural network;
applying the data to a classifier of the neural network to determine classification probabilities for the data as one bit quantized weights ;
applying a loss function to the classification probabilities for the data, the loss function comprising a regularizer, wherein the regularizer forces weights of the classification probabilities to converge to binary integers, wherein the regularizer exhibits a smooth curve with a continuously turning tangent at a midpoint; and
outputting the one bit quantized weights of the classification probabilities for the data.

2. The method of claim 1, wherein the regularizer comprises a Euclidean regularizer.

3. The method of claim 1, wherein the regularizer comprises a Cosinus regularizer.

4. The method of claim 1, wherein the regularizer comprises a Manhattan regularizer.

5. The method of claim 1, wherein the regularizer further exhibits real angles at the binary integers.

6. The method of claim 1, further comprising:
applying a decay function to the regularizer over a number of epochs to force convergence to the binary integers.

7. The method of claim 6, wherein the decay function comprises at least one of: linear, quadratic polynomial, n-polynomial, inverse linear decay, inverse polynomial decay, step-based inverse linear decay, step-based bounded decay, and step-based linear decay.

8. A method for performing N bit quantization of data, the method comprising:
receiving data for training a neural network;
multiplexing the data;
scaling the multiplexed data according to multipliers;
applying the multiplexed data to a classifier of the neural network to determine classification probabilities for the multiplexed data as N bit quantized weights;
applying a loss function to the classification probabilities for the multiplexed data, the loss function comprising a regularizer, wherein the regularizer forces weights of the classification probabilities to converge to N integers, wherein the regularizer exhibits a smooth curve with a continuously turning tangent at a midpoint; and
outputting N values of the N bit quantized weights of the classification probabilities for the data.

9. The method of claim 8, wherein the regularizer comprises a Euclidean regularizer.

10. The method of claim 8, wherein the regularizer comprises a Cosinus regularizer.

11. The method of claim 8, wherein the regularizer comprises a Manhattan regularizer.

12. The method of claim 8, wherein the regularizer further exhibits real angles at the N integers.

13. The method of claim 8, further comprising:
applying a decay function to the regularizer over a number of epochs to force convergence to the N integers.

14. The method of claim 13, wherein the decay function comprises at least one of: linear, quadratic polynomial, n-polynomial, inverse linear decay, inverse polynomial decay, step-based inverse linear decay, step-based bounded decay, and step-based linear decay.

15. An system for quantization of data, the system comprising:
a memory; and
a processor configured to:
receive data for training a neural network;
apply the data to a classifier of the neural network to determine classification probabilities for the data as quantized weights;
apply a loss function to the classification probabilities for the data, the loss function comprising a regularizer, wherein the regularizer forces weights of the classification probabilities to converge to binary integers, wherein the regularizer exhibits a smooth curve with a continuously turning tangent at a midpoint; and
output the quantized weights of the classification probabilities for the data.

16. The system of claim 15, wherein the quantized weights are one bit quantized weights, such that the processor is configured to output one bit quantized weights.

17. The system of claim 15, wherein the quantized weights are N bit quantized weights, such that the processor is configured to output N bit quantized weights.

18. The system of claim 17, wherein the processor is further configured to:
multiplex the data; and
scale the multiplexed data according to multipliers.

19. The system of claim 15, wherein the processor is further configured to:
apply a decay function to the regularizer over a number of epochs to force convergence to the binary integers.

20. The system of claim 15, wherein the regularizer further exhibits real angles at the binary integers.
